(19) United States
(12) Patent Application Publication
(10) Pub. No.: US 2023/0100809 A1
(43) Pub. Date: Mar. 30, 2023

(54) BATTERY DISTRIBUTION METHOD, DEVICE, SYSTEM, EQUIPMENT AND MEDIUM

(71) Applicant: Beijing Tusen Weilai Technology Co., Ltd., Beijing (CN)

(72) Inventor: Nan WU, Beijing (CN)

(21) Appl. No.: 17/937,303

(22) Filed: Sep. 30, 2022

Related U.S. Application Data
(60) Provisional application No. 63/250,929, filed on Sep. 30, 2021.

(51) Int. Cl. G06Q 10/06; B60L 53/80; B60L 3/12; B60W 60/00; G06Q 50/30; G06Q 10/02

(52) U.S. Cl. CPC G06Q 10/06315; B60L 53/80; B60L 3/12; B60W 60/0025; G06Q 50/30; G06Q 10/02; B60L 2240/66

(57) ABSTRACT

A battery distribution method, a device, a system, equipment and a medium. The method comprises: generating a benchmark for transportation and battery swapping of a vehicle according to transportation history information and battery swapping history information of the vehicle; updating the battery swapping information of a road port according to the transportation plan of the vehicle and the benchmark; and generating a battery distribution plan of the road port according to the number of available batteries at the road port and the battery swapping information of the road port. The available batteries after the distribution in each road port can meet the actual battery swapping demand. Also, the battery distribution mode in road ports during the vehicle transportation is simplified and automated, and the accuracy and the high efficiency of battery distribution in road ports are improved.

### CROSS-REFERENCE TO RELATED APPLICATION(S)

This application claims the benefit of priority of U.S. Provisional Patent Application No. 63/250,929, entitled “BATTERY DISTRIBUTION METHOD, DEVICE, SYSTEM, EQUIPMENT AND MEDIUM” filed on Sep. 30, 2021, which is incorporated by reference in its entirety herein.

### TECHNICAL FIELD

The present document relates generally to autonomous vehicles and, more specifically, to methods and systems which enable predictable and automatic swapping of autonomous vehicle batteries.

### BACKGROUND

Self-driving or autonomous vehicles can be autonomously controlled to navigate along a path to a destination. Autonomous vehicles can use various engine types including, e.g., internal combustion or electric engines or motors.

### SUMMARY

The techniques disclosed herein can be implemented in various embodiments to provide battery swapping methods, devices, systems, equipment and media for autonomous vehicles.

In a first aspect, an embodiment provides a battery distribution method, which comprises: generating a benchmark for transportation and battery swapping of a vehicle according to transportation history information and battery swapping history information of the vehicle, wherein the benchmark represents a corresponding relation between a transportation plan and a battery swapping demand of the vehicle; updating the battery swapping information of a road port according to the transportation plan of the vehicle and the benchmark, wherein the battery swapping information of the road port is determined based on the vehicle stopping at the road port; and generating a battery distribution plan of the road port according to the number of available batteries at the road port and the battery swapping information of the road port.

In a second aspect, an embodiment provides a battery distribution device, which comprises: a battery swapping benchmark generation module, configured for generating a benchmark for transportation and battery swapping of a vehicle according to transportation history information and battery swapping history information of the vehicle, wherein the transportation and battery swapping benchmark represents a corresponding relation between a transportation plan and a battery swapping demand of the vehicle; a battery swapping updating module, configured for updating the battery swapping information of a road port according to the transportation plan of the vehicle and the benchmark; and a battery distribution module, configured for generating a battery distribution plan of the road port according to the number of available batteries at the road port and the battery swapping information of the road port.

In a third aspect, an embodiment provides a battery distribution system, which comprises a battery swapping planning system on a server, an automatic battery swapping device in a road port and a battery swapping system on a vehicle, wherein the battery swapping planning system on the server is configured for generating a benchmark for transportation and battery swapping of the vehicle according to transportation history information and battery swapping history information of the vehicle, the benchmark representing a corresponding relation between a transportation plan and a battery swapping demand of the vehicle, for updating the battery swapping information of the road port according to the transportation plan and the benchmark, for generating a battery distribution plan of the road port according to the number of available batteries at the road port and the battery swapping information of the road port, and for sending the transportation plan generated for any vehicle and the battery swapping information of the road port to the battery swapping system on the vehicle; the battery swapping system on the vehicle is configured for receiving the transportation plan generated by the battery swapping planning system on the server for the vehicle and the battery swapping information of the road port, for enabling the vehicle to stop at the road port according to the transportation plan and loading and unloading goods according to the quantity of goods to be loaded of the road port, and for sending the battery swapping information of each road port to the automatic battery swapping device in the road port; the automatic battery swapping device at the road port is configured for swapping the battery of the vehicle according to the battery swapping demand of the vehicle upon stopping at the road port.

In a fourth aspect, an embodiment provides a server, which comprises: one or more processors; and a storage device, configured for storing one or more programs; the one or more processors, when executing the one or more programs, implement the battery distribution method according to any embodiment of the present invention.

In a fifth aspect, an embodiment of the present invention provides a computer-readable storage medium, having a computer program stored thereon, wherein the program, when executed by a processor, implements the battery distribution method according to any embodiment of the present invention.

An aspect of the disclosed embodiments relates to a battery distribution method that includes generating a relationship between a transportation plan and a battery swapping demand of a vehicle using transportation history information and battery swapping history information of the vehicle. The method further includes updating battery swapping information of a road port according to the transportation plan of the vehicle and the relationship, wherein the battery swapping information of the road port is determined based on a battery swapping demand of one or more vehicles. The method also includes generating a battery distribution plan for the road port according to a number of available batteries at the road port and the battery swapping information of the road port.

Another aspect of the disclosed embodiments relates to a battery distribution device that includes a battery swapping benchmark generation module, configured to generate a benchmark for transportation and battery swapping of a vehicle according to transportation history information and battery swapping history information of the vehicle, wherein the benchmark represents a corresponding relationship between a transportation plan and a battery swapping demand of the vehicle. The device further includes a battery swapping updating module, configured to update battery swapping information of a road port according to the transportation plan of the vehicle and the benchmark, wherein the battery swapping information of the road port is determined based on battery swapping demand of one or more vehicles. The device also includes a battery distribution module, configured to generate a battery distribution plan of the road port according to a number of available batteries at the road port and the battery swapping information of the road port.

Yet another aspect of the disclosed embodiments relates to a battery distribution system that includes a battery swapping planning system, an automatic battery swapping device and a battery swapping system. The battery swapping planning system of the battery distribution system is configured to: generate a benchmark for transportation and battery swapping of a vehicle according to transportation history information and battery swapping history information of the vehicle, the benchmark representing a corresponding relationship between a transportation plan and a battery swapping demand of the vehicle; update the battery swapping information of a road port according to the transportation plan and the benchmark; generate a battery distribution plan of the road port according to a number of available batteries at the road port and the battery swapping information of the road port; and send the transportation plan generated for the vehicle and the battery swapping demand of the vehicle at the road port to the battery swapping system on the vehicle. The battery swapping system of the battery distribution system is configured to: receive the transportation plan generated by the battery swapping planning system for the vehicle and the battery swapping demand of the vehicle at the road port; enable the vehicle to stop at the road port according to the transportation plan and load or unload goods according to quantity of goods to be loaded or unloaded at the road port; and send the battery swapping demand of vehicle to the automatic battery swapping device in the road port. The automatic battery swapping device of the battery distribution system is configured to swap a battery of the vehicle according to the battery swapping demand of the vehicle upon the vehicle stopping at the road port.

An aspect of the disclosed embodiments relates to a server that includes one or more processors and a storage device configured to store one or more programs, wherein the one or more programs, upon execution by the one or more processors, cause the server to implement a battery distribution method according to the present disclosure.

Another aspect of the disclosed embodiments relates to a non-transitory computer-readable storage medium, having a computer program stored thereon, wherein the program, when executed by a processor, causes the processor to implement a battery distribution method according to the present disclosure.

The embodiments of the present invention provide a battery distribution method, a device, a system, equipment and a medium, wherein the method comprises: firstly analyzing a corresponding relation between a transportation plan and an actual battery swapping demand during vehicle transportation according to transportation history information and battery swapping history information of a vehicle to obtain a corresponding benchmark for transportation and battery swapping; and then updating the battery swapping information of each road port according to the transportation plan of the vehicle and the benchmark, and further generating a battery distribution plan of the road port according to the number of available batteries at the road port and the battery swapping information of the road port, so as to enable the available batteries after the distribution in each road port to meet the actual battery swapping demand and thus to realize the automatic battery distribution in road ports during the vehicle transportation. In this method, the battery distribution mode in road ports during the vehicle transportation is simplified, the problems of the complicated distribution mode and heavy distribution workload during manual battery distribution of each road port are solved, and the accuracy and the high efficiency of battery distribution in road ports are improved.

### BRIEF DESCRIPTION OF THE DRAWINGS

FIG. 1 shows a schematic diagram illustrating the principle of a battery distribution system according to the present disclosure.

FIG. 2 shows a schematic flowchart of a battery distribution method according to an example embodiment.

FIG. 3 shows a schematic flowchart of a battery distribution method according to another example embodiment.

FIG. 4 shows a schematic flowchart of a battery distribution method according to yet another example embodiment.

FIG. 5 shows a schematic diagram illustrating the structure of a battery distribution device according to the present disclosure.

FIG. 6 is a schematic diagram showing the structure of a server according to an example embodiment.

### DETAILED DESCRIPTION

At present, vehicles such as, e.g., electric heavy trucks are increasingly widely available in the field of long-distance transportation to transport goods, so as to ensure energy conservation and environmental protection during vehicle travel. However, efficient long-distance transportation currently cannot be realized for such vehicles due to insufficient travel range determined by limited capacity of the electric batteries that power electric motor(s) of the vehicle and long charging durations required to recharge the vehicle batteries. Accordingly, there is still a need to provide methods and systems which could increase range of travel of electric trucks.

The techniques disclosed herein overcome the shortcomings of prior systems and can be implemented in various embodiments to provide battery swapping methods and systems. The disclosed methods and systems, among other features and benefits, simplify distribution of batteries for autonomous vehicles to road ports, and improve accuracy and efficiency of battery distribution methods.

The disclosed technology will be further described in detail with reference to the drawings and example embodiments. It will be appreciated that the specific embodiments described herein are merely illustrative of the present disclosure and are not to be construed as limiting the present disclosure. It should be further noted that, for the convenience of description, only some, but not all, structures associated with the present disclosure are shown in the drawings. In addition, the embodiments and features thereof in the present disclosure may be combined with one another without conflict.

During long-distance transportation when the vehicles travel long distances, a standby battery replacement (or battery swapping) mode may be adopted. Therefore, battery swapping stations arranged in road ports require continuous distribution of the corresponding amounts of standby batteries for battery swapping with vehicles during long-distance transportation. However, when standby batteries are distributed to battery swapping stations arranged in road ports, workers can check the number of the remaining standby batteries in real time after battery swapping to determine whether the standby batteries need to be distributed (e.g., delivered to the battery replacement/swapping stations from a battery storage facility which may be located within or outside the road port) or not; or, the distribution operation of the standby batteries can be implemented once after each battery swapping. Currently, the model of distribution of standby batteries after battery swapping is complicated, and thus greatly increases the standby battery distribution workload of the battery swapping stations at the road ports.

Given that an autonomous vehicle (e.g., an autonomous electric truck) can be subjected to battery swapping in each road port it stops at during long-distance transportation so as to ensure its long-distance travel, the corresponding amounts of available batteries are required to be distributed to each road port so as to facilitate the successful battery swapping during the vehicle transportation (also referred to as vehicle travel or transportation of cargo by the vehicle). Therefore, in order to effectively plan the battery distribution in each road port during vehicle transportation, the present disclosure provides methods and systems for supporting battery distribution in (or to) each road port during long-distance vehicle transportation, so as to enable the available batteries after the distribution in each road port to meet the actual battery swapping demand during long-distance vehicle transportation, to realize the automatic battery distribution in road ports during vehicle transportation, and to ensure the successful battery swapping during vehicle transportation.

FIG. 1 shows a schematic diagram of an example embodiment of a battery distribution system, which is applicable to, e.g., a situation where batteries are distributed to each road port and a vehicle is subjected to battery swapping at the road port during long-distance vehicle transportation. As shown in FIG. 1, the battery distribution system may comprise a battery swapping planning system 110 on a server, an automatic battery swapping device 120 in a road port and a battery swapping system 130 on an autonomous vehicle. In some example embodiments, the battery swapping planning system 110 may be implemented in or using a remote server (which can be also referred to as a cloud server). The remote server can be located at a distance from the autonomous vehicle and/or the road port. The remote server can be located at a location other than that of the autonomous vehicle and/or the road port.

The battery swapping planning system 110 on the server can be configured to generate a benchmark (which can also be referred to as a reference, a model, a dependence, a function, or a relationship) for transportation and battery swapping of an autonomous vehicle according to or using transportation history information and battery swapping history information related to the vehicle. The benchmark may represent a relationship between a transportation plan and a battery swapping demand of the vehicle (referred to as a battery swapping relationship below). The battery swapping relationship may be used to determine the number and/or the total capacity and/or the type of the batteries which need to be replaced at certain points (e.g., locations and/or time points) during vehicle travel along a travel path or route.

The transportation plan for a vehicle may include, e.g., a travel path or a route of the vehicle, information related to the weight of the vehicle and/or vehicle load (e.g., the weight of the vehicle including the weight of the cargo/goods the vehicle is or will be carrying along the path or along different parts of the path which may be referred to as the gross weight of the vehicle; or, the weight of the vehicle without any cargo or passengers in it). The transportation plan may also include a schedule of deliveries or pickups which the vehicle should perform along its path of travel. The schedule may include information related to places or locations (e.g., road ports, sea ports, warehouses, storage or processing facilities, stores, shops, manufacturing plants, etc.) which the vehicle should stop at along the path, information related to the amount (e.g., weight) and type of goods the vehicle should unload or load at those locations, and/or information related to times (e.g., dates and/or hours, minutes, etc.) when the vehicle should arrive at those locations. The locations may be specified as global positioning system (GPS) coordinates for example. When we refer to a road port in this patent document, we generally refer to any of the mentioned road ports, sea ports, warehouses, storage or processing facilities, stores, shops, manufacturing plants, etc. The transportation plan for a vehicle may also include information related to when and/or where the vehicle should stop to replace one or more of its batteries and the number of batteries which need to be replaced. The transportation plan for a vehicle may be generated by, e.g., battery swapping planning system 110 in some example embodiments.

The battery swapping demand of the vehicle, when the vehicle is, e.g., an electric or a hybrid one may be related to a maximum distance the vehicle can travel along a route carrying a cargo load, and/or following a certain speed profile (e.g., a dependence of the vehicle speed on a distance along the route) when the vehicle uses only electric motor(s) for its motion. The battery swapping demand may be related, among other factors, to a total capacity of the vehicle batteries which are used to drive electric motor(s) of the vehicle. Accordingly, the battery swapping demand may be expressed as a capacity (or a number) of the vehicle batteries which will be expended or used to propel the vehicle by, e.g., 1 mile or 1 kilometer (or, e.g., by 100 or 1000 miles or kilometers) along a path (e.g., when the vehicle is carrying a certain cargo load). The battery swapping demand may be also related to a (maximum) time duration of an electric vehicle operation when the vehicle carries a certain weight of goods. The battery swapping demand may be used to determine the number of batteries of the vehicle which need to be replaced at a certain road port.

The battery swapping relationship between the transportation plan and the battery swapping demand of an autonomous vehicle may be obtained using transportation history information and battery swapping history information related to the vehicle.

The transportation history information may include information about transportation plans of the vehicle over a certain time period (e.g., last 3 or 6 months, or another time period).

The battery swapping history information may include information related to instances when one or more batteries of the vehicle were swapped at, e.g., a road port for another battery or batteries. Battery swapping history information may include such information as when the battery swapping took place and number and/or capacity of the newly-installed batteries. The battery swapping history information may also include information related to a dependence of the remaining capacity of vehicle batteries on the distance of the vehicle travel. For example, measurements, determinations or estimates of the remaining capacity of the vehicle batteries may be performed when the vehicle makes a stop at a road port using, e.g., port's equipment. Alternatively or additionally, such measurements/determinations/estimates may be performed using devices (e.g., sensors) of the vehicle, e.g., continuously, or in predetermined time intervals.

Battery swapping information of a road port may include information about the number and/or capacity of the batteries which the road port should have to satisfy the battery swapping demand (e.g., projected or estimated demand) for replacement batteries for the vehicles which will be stopping at the port at a certain time or during, e.g., a certain time interval (e.g., during the next 24 hours, 3 days, or a week). The battery swapping information of a road port may be updated according to the transportation plan of the vehicle and the battery swapping relationship for the vehicle. The battery swapping information of the road port may also include identification information of a vehicle that will require replacing one or more of its batteries and information about a number, type, and/or capacity of the batteries which should be replaced on that particular vehicle.

A battery distribution plan for a road port may be generated according to the number of available batteries at the road port and the battery swapping information of the road port. The battery distribution plan may include information related to the number of batteries which need to be delivered to the port, source(s) from which the batteries can be delivered to the port and a timeframe or a schedule for delivering the batteries. The battery distribution plan may include information related to how the replacement batteries within the port should be distributed among the battery swapping stations or battery swapping devices within the port. E.g., how many replacement batteries should each such device have.

Furthermore, the battery swapping planning system 110 may be configured to send the transportation plan generated for the vehicle and the battery swapping information of the road port to the battery swapping system 130 on the vehicle. Battery swapping information of the road port sent to the vehicle may also include information related to the battery swapping device which the vehicle should use when it arrives to the road port.

The battery swapping system 130 on the vehicle may be configured to receive the transportation plan generated by the battery swapping planning system 110 on the server for the vehicle and the battery swapping information of the road port. The battery swapping system 130 may, e.g., in cooperation with the vehicle control system of an autonomous vehicle, control the autonomous vehicle to stop at the road port(s) according to the transportation plan, load or unload goods according to the quantity of goods to be loaded or unloaded at the road port. The battery swapping system 130 may also send battery swapping information to an automatic battery swapping device 120 in the road port. The battery swapping information may include, e.g., the battery swapping information of the road port (e.g., identification information of the vehicle and information about the number, type, or capacity of the batteries which should be replaced on the vehicle by a battery swapping device in the port).

The automatic battery swapping device 120 at the road port may be configured to swap one or more batteries of the vehicle according to the battery swapping demand of the vehicle upon the vehicle stopping at the road port.

For example, when a vehicle departs (or before the vehicle departs) from an originating road port, the battery swapping planning system 110 on the server may determine a functional relationship between transportation plan and battery swapping demand of the vehicle by, e.g., analyzing the transportation history information and the battery swapping history information of the vehicle related to long-distance transportation trips performed by the vehicle, so as to generate a corresponding battery swapping relationship between transportation and battery swapping of the vehicle. Then, the swapping planning system 110 may determine the road port or ports in which the vehicle needs to implement or undergo the battery swapping operation, the number of the vehicle batteries to be swapped/replaced (e.g., in each of these ports) and other information according to the transportation plan of the vehicle. The swapping planning system 110 may perform the described actions for each vehicle departing from the originating road port. The swapping planning system 110 may also determine, generate, or receive the battery swapping information of each road port (e.g., each road port along the travel path of the vehicle or each road port in which the vehicle will be making a stop). The battery swapping information of a road port may be determined, generated or received with reference to the functional relationship between the transportation plan and the battery swapping demand represented by the battery swapping relationship. Furthermore, the swapping planning system 110 may be configured to generate a battery distribution plan for a road port by determining whether the number of available batteries at the road port meets the requirement on the number of available batteries according to the battery swapping information of this road port or not. The battery distribution plan at least may comprise information such as the number of batteries which need to be delivered to the road port. The battery distribution plan may also comprise information such as the number of batteries which need to be delivered to each battery swapping device or station 120 within the port. Implementation of the battery distribution plan should enable the number of available batteries after the distribution at and/or within the road port to meet the actual battery swapping/replacement demand of the vehicle during its travel, thereby avoiding the failure to perform battery swapping due to insufficient number of available batteries at the road port.

Different vehicles may have different configuration, so the functional relationship between transportation plan and battery swapping demand of each vehicle can be determined separately; or, vehicles can be classified according to the configuration, so the functional relationship between transportation plan and battery swapping demand of vehicles with the same configuration can be determined at the same time.

The battery swapping planning system 110 may be configured to send a transportation plan of a vehicle and a battery swapping demand of the vehicle at a road port (e.g., the first road port where the vehicle will make a stop along its route) to the battery swapping system 130 of the vehicle, e.g., after generating the transportation plan of the vehicle and determining battery swapping demand of the vehicle at the road port. The battery swapping demand of the vehicle at the road port may refer to the number and/or (total) capacity of the vehicle batteries which need to be replaced at the road port. Accordingly, the battery swapping system 130 of the vehicle may be configured to receive the transportation plan and the battery swapping demand of the vehicle at the road port. The battery swapping system 130 of the vehicle may be located or disposed in, within, or on the vehicle.

The battery swapping system 130 of the vehicle may be further configured to control the vehicle to automatically stop at each road port according to the transportation plan, load and/or unload goods according to the quantity of goods to be loaded or unloaded by the vehicle at each road port, and send a battery swapping demand to an automatic battery swapping device 120 in each road port, so as to enable the vehicle to automatically stop at a designated battery swapping position in each road port, and to enable the communication with the automatic battery swapping device 120 in each road port through a vehicle-mounted communication device to implement the battery swapping operation of the vehicle.

The automatic battery swapping device 120 at the road port may be configured to implement the battery swapping operation on the vehicle, in response to receiving the battery swapping demand from the vehicle stopping at the road port, by adopting or using, according to this battery swapping demand, a battery available at the road port, so as to ensure the long distance transportation of the vehicle.

The present disclosure provides details of the specific procedures of battery distribution and battery swapping implemented by the battery swapping planning system 110 on the server, the automatic battery swapping device 120 at the road port, and the battery swapping system 130 on the vehicle using descriptions of the following example embodiments.

### Example Embodiment I

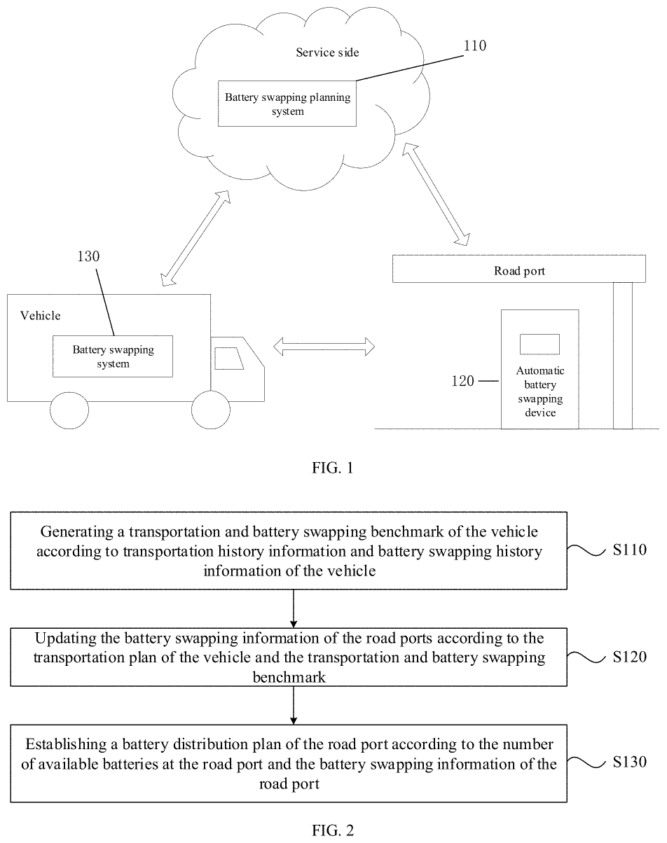

FIG. 2 is a schematic flowchart of a battery distribution method according to an example Embodiment I, which is applicable to, e.g., a situation where batteries are distributed to each road port and a vehicle is subjected to battery swapping at the road port during long-distance vehicle transportation or travel. The battery distribution method according to this embodiment may be implemented using a battery distribution device according to an embodiment of the present disclosure. Specifically, the battery distribution device may implement this method in a manner of software and/or hardware and can be integrated in a server executing this method. Moreover, the battery distribution method according to the Embodiment I may be implemented by the battery swapping planning system on the server of the battery distribution system described above.

Specifically, referring to FIG. 2, the method 100 may comprise the following steps:

S110, a battery swapping relationship (referred to as benchmark) for transportation and battery swapping of the vehicle is generated according to transportation history information and battery swapping history information of the vehicle.

Specifically, considering that the battery distribution in each road port is related to the battery swapping situation (e.g., demand) upon stopping of the vehicle in this road port during long-distance vehicle travel, the battery swapping situation/demand in each road port during vehicle transportation is determined according to an example embodiment.

According to the example Embodiment I, transportation history information and battery swapping history information of the vehicle during previous long-distance transportation is obtained. The transportation history information may include a driving route, a vehicle driving state (e.g., whether the vehicle is driving in an autonomous mode or manually operated, dependencies of vehicle velocity and/or acceleration along the driving route, etc.), power consumption and the like of the vehicle during historic/previous transportations. The battery swapping history information may be a battery swapping demand of the vehicle upon stopping at different road ports (e.g., how many batteries were replaced at each road port). Then, by analyzing the road ports at which the vehicle stops according to the transportation history information and the battery swapping demand of the vehicle upon stopping at the road port in the battery swapping history information, the functional relationship between the transportation plan and the battery swapping demand during vehicle transportation can be determined, so that the battery swapping relationship for transportation and battery swapping of the vehicle is determined, wherein the battery swapping relationship may represent a functional relationship between the transportation plan and the battery swapping demand of the vehicle, which facilitates the subsequent updating of the battery swapping information of the road port according to the transportation plan of the vehicle on the basis of meeting the actual battery swapping demand of the road port.

At S120, the battery swapping information of the road ports is updated according to the transportation plan of the vehicle and the battery swapping relationship.

According to the example Embodiment I, when the vehicle departs from an originating road port, a transportation plan of the vehicle can be generated according to a transportation situation of the vehicle and a distribution of road ports. The transportation plan can be used to control the actual transportation of the vehicle according to the transportation plan. The transportation plan of the vehicle may include, e.g., locations of the road ports the vehicle can stop at during transportation, a quantity of goods loaded into or onto the vehicle and/or a number of batteries which need to be swapped upon stopping of the vehicle at each of the road ports.

After the transportation plan of the vehicle is determined (e.g., in advance of the current vehicle transportation or travel), the battery swapping demand of the vehicle during its travel can be determined according to the functional relationship between the transportation plan and the battery swapping demand represented by the battery swapping relationship, and then the battery swapping information of each road port can be updated according to the battery swapping demand, so that the battery swapping information of each road port where the vehicle is projected to stop and replace/swap some or all of its batteries can meet the battery swapping demand of the vehicle during its travel, thereby avoiding the failure to swap vehicle batteries due to insufficient available batteries at the road port.

According to the example Embodiment I, the battery swapping information of the road port may include: stopping time for battery swapping at the road port, vehicle information corresponding to the stopping time for battery swapping at the road port, and/or a power exchange amount corresponding to the stopping time for battery swapping of the road port. The stopping time for battery swapping at the road port may correspond to the time at which a vehicle stops at the road port for battery swapping. The power exchange amount corresponding to the stopping time for battery swapping of the road port may correspond to the number and/or a total capacity of the batteries that need to be replaced (or swapped or exchanged) on the vehicles that stop at the road port at or around the stopping time. The vehicle information may include, e.g., vehicle license plate number, vehicle make, model, color, etc. For example, when a vehicle departs from the originating road port, transportation plans of all vehicles traveling in the current transportation process (e.g., during a certain time frame or interval) can be analyzed. According to the transportation plans of the vehicles and the related battery swapping relationships for transportation and battery swapping, stopping times for battery swapping of the vehicles and power exchange amounts corresponding to the stopping times for battery swapping may be determined, and then the battery swapping information of the road ports can be updated, thereby ensuring the accuracy of the battery swapping demand of each road port.

At S130, a battery distribution plan of the road port can be generated according to the number of available batteries at the road port and the battery swapping information of the road port.

For example, after the battery swapping information of each road port is determined, the number of available batteries in each road port can be obtained through, e.g., the road port network, and can be used to determine whether the number of available batteries in each road port can meet the battery swapping demand of this road port, so as to generate a battery distribution plan of each road port.

It should be noted that, in order to ensure the accuracy of the amount of available batteries in each road port, a timing of generating the battery distribution plan of the road port may include any one of the following timings, according to example embodiments:

1) In response to a request of a vehicle for departure from a road port.

Each vehicle, for example, when departing from an originating road port from which the vehicle starts a transportation, may upload or send a battery swapping request to a battery swapping planning system on a server, and at this point, since the battery swapping demand for each road port is changed (e.g., in response to the battery swapping request made by the vehicle), the battery swapping planning system may implement a battery distribution procedure according to the above steps, so as to regenerate a battery distribution plan for all road ports, and thus to ensure the accuracy of the distribution of available batteries in road ports.

2) In response to a battery swapping operation implemented by the automatic battery swapping device at a road port on a vehicle.

Given that the available batteries in a road port are reduced after the automatic battery swapping device in the road port successfully implements a battery swapping operation, in order to avoid the shortage of the available batteries in the road port, a battery distribution procedure can be re-implemented according to the above steps, and a battery distribution plan can be regenerated for the road port, so as to ensure the accuracy of the distribution of the available batteries at the road port.

3) In response to distribution of standby batteries (e.g., standby batteries are the batteries which will be exchanged with the batteries of the vehicles stopping at the road port) to each road port is finished according to the latest battery distribution plan.

After the distribution of standby batteries in each road port is finished according to the latest battery distribution plan, in order to avoid battery distribution omission, the current number of available batteries of each road port are re-obtained, and then a battery distribution plan is regenerated, so as to ensure the comprehensiveness of the battery distribution in each road port.

4) In response to a condition where the number of available batteries at a road port is less than or equal to a preset battery swapping threshold.

When the number of available batteries at a road port is less than or equal to a preset battery swapping threshold, it is indicated that the number of the available batteries at the road port is insufficient, and thus the battery distribution is needed. Therefore, in this embodiment, a battery distribution procedure can be implemented according to the above steps, and a battery distribution plan for each road port can be regenerated, so as to ensure the accuracy of the distribution of available batteries at road ports.

According to the technical scheme provided by the example Embodiment I, a functional relationship between a transportation plan and battery swapping demand during vehicle transportation is determined according to transportation history information and battery swapping history information of a vehicle and a corresponding battery swapping relationship is generated for transportation of the vehicle and battery replacement during the vehicle transportation. Furthermore, the battery swapping information of each road port is updated according to the transportation plan of the vehicle and the battery swapping relationship, and furthermore, a battery distribution plan of a road port may be generated according to the number of available batteries at the road port and the battery swapping information of the road port so as to enable the available batteries after the distribution in each road port to meet the battery swapping demand and thus to realize the automatic battery distribution in road ports during the vehicle transportation. As a result of the example Embodiment I implementation, the battery distribution mode in road ports during the vehicle transportation is simplified, the problems of the complicated distribution mode and heavy distribution workload during manual battery distribution of each road port are solved, and the accuracy and the high efficiency of battery distribution in road ports are improved.

### Example Embodiment II

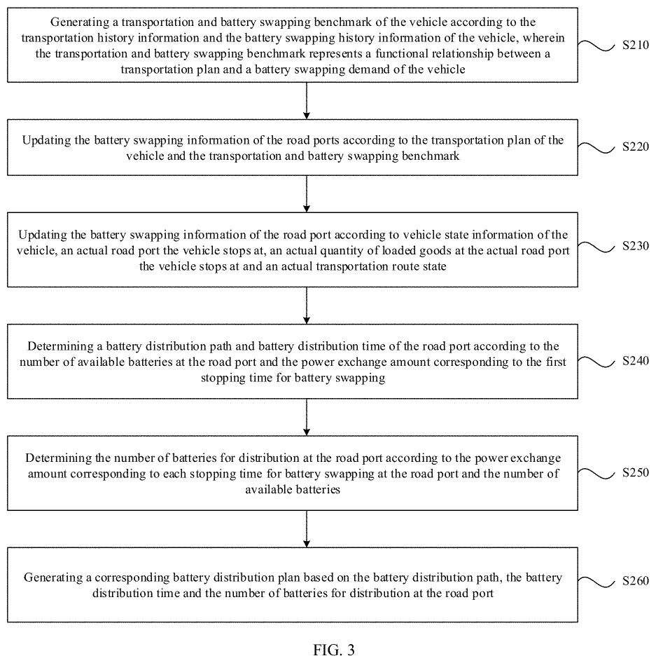

FIG. 3 shows a schematic flowchart of a battery distribution method according to example Embodiment II according to the present disclosure. This embodiment is optimized based on the above embodiment. Specifically, this embodiment mainly explains in detail the specific procedures of generating a battery distribution plan for each road port.

As shown in FIG. 3, example Embodiment II may comprise the following steps:

At S210, a battery swapping relationship for transportation and battery swapping of the vehicle is generated according to the transportation history information and the battery swapping history information of the vehicle, wherein the battery swapping relationship represents a functional relationship between a transportation plan and a battery swapping demand of the vehicle.

At S220, the battery swapping information of the road ports is updated according to the transportation plan of the vehicle and the battery swapping relationship.

At S230, the battery swapping information of the road port is updated according to vehicle state information of the vehicle, an actual road port the vehicle stops at, an actual quantity of loaded or unloaded goods at the actual road port the vehicle stops at and an actual transportation route state.

There is a difference between a transportation route in a transportation plan generated when a vehicle departs from an originating road port and an actual road condition (or route) during actual transportation, leading to changes in power consumption of the vehicle, wherein the originating road port is a road port from which the vehicle starts the transportation plan. Therefore, in this embodiment, in order to ensure the accuracy of the battery swapping information of each road port, the battery swapping information of each road port is updated once after the vehicle is departing from the originating road port, and vehicle state information of the vehicle and an actual road port at which the vehicle stops are analyzed in real time during the transportation, meanwhile, an actual quantity of loaded goods and an actual transportation route state of the vehicle in each actual road port the vehicle stops at are determined, so as to analyze the influence of the road condition in the actual transportation state on the power consumption of the vehicle, and then to update the battery swapping information of each road port, thereby updating an actual battery swapping demand of each road port in real time and ensuring the flexibility and the accuracy of battery distribution.

In this and other embodiments, the vehicle state information of the vehicle may include at least: a vehicle weight, a loading capacity, average power consumption, remaining power of the vehicle, and/or the number, capacity or type of the vehicle batteries which need or will need to be replaced; the actual transportation route state may include at least: actual weather information of the transportation route, road congestion information and/or a running state of the road port. The running state of the road port may include information related to operation of the road port such as, e.g., whether the port is open or not, available processing capacity of the port, etc. The above information can be provided to accurately analyze the power consumption of the vehicle during the transportation, thereby ensuring the accuracy of the battery swapping information upon stopping of the vehicle at each road port.

At S240, a battery distribution path and battery distribution time of the road port are determined according to the number of available batteries at the road port and the power exchange amount corresponding to the first stopping time for battery swapping.

A battery distribution path may be a path or a route along which batteries can be delivered to a road port. Battery distribution time may be a time or a time period when the batteries should be or can be delivered to the road port.

The power exchange amount may refer to the total capacity and/or number of the batteries which need to be exchanged or replaced or swapped at the road port at the first stopping time.

The first stopping time for battery swapping may refer to the stopping time for battery swapping when a first vehicle arrives at a road port according to the time sequence of the stopping time for battery swapping of vehicles stopping at this road port, namely the latest stopping time sequence for battery swapping of the vehicles stopping at this road port.

In this embodiment, the battery swapping information of each road port may at least include stopping time for battery swapping at the road port, vehicle information corresponding to the stopping time for battery swapping, and a power exchange amount corresponding to the stopping time for battery swapping. The vehicle information may include, e.g., vehicle license plate number, vehicle make, model, color, etc. At this point, by analyzing the number of available batteries in the road port and determining whether the number of available batteries in the road port meets the power exchange amount corresponding to the first stopping time for battery swapping of the vehicle at the road port, the (emergency) degree of battery distribution in each road port may be obtained. The degree of battery distribution may correspond to the number of batteries which need to be delivered to a road port so that the road port has a number of batteries sufficient to perform battery replacement on the vehicles stopping at the road port. Then a battery distribution path and battery distribution time for each road port are determined according to the degree of battery distribution in each road port and the first stopping time for battery swapping at the road port, and at this point, the battery distribution path can enable each road port to at least have enough available batteries before the first stopping time for battery swapping so as to meet the power exchange amount corresponding to the first stopping time, thereby increasing the efficiency of battery distribution.

It should be noted that, in this embodiment, in response to a battery swapping operation successfully implemented each time at the road port, the number of available batteries at the road port may be acquired or provided through an automatic battery swapping device at the road port. That is to say, after each successful completion of battery swapping in each road port, the number of the remaining available batteries after battery swapping in this road port is checked once through the automatic battery swapping device at the road port, and then reported to a battery swapping planning system on a server, so as to enable the battery swapping planning system to obtain the latest information of the number of available batteries in each road port.

At S250, the number of batteries for distribution at (or to) the road port is determined according to the power exchange amount corresponding to each stopping time for battery swapping and the number of available batteries at the road port.

Optionally, the total power exchange amounts of each road port for vehicles can be determined by analyzing the power exchange amount corresponding to each stopping time for battery swapping at a road port, and then the battery number which is still lacking for the battery swapping in the road port can be analyzed according to the number of available batteries in the road port and the total power exchange amounts of the road port, so as to determine the number of batteries for distribution or delivery to the road port.

At S260, a corresponding battery distribution plan is generated based on the battery distribution path, the battery distribution time and the number of batteries for distribution at the road port.

After the battery distribution path, the battery distribution time and the number of batteries for distribution to each road port are obtained, the battery distribution paths, the battery distribution times and the numbers of batteries for distribution to road ports can be integrated or combined to form a corresponding battery distribution plan, so that a corresponding number of standby/replacement batteries for distribution can be distributed to each road port through a corresponding battery distribution path at the battery distribution time according to the information in the battery distribution plan.

According to the technical scheme provided by the example Embodiment II, a battery distribution path, battery distribution time and a number of batteries for distribution in each road port are determined according to the number of available batteries in each road port and the power exchange amount corresponding to the latest information of first stopping time for battery swapping, and then a corresponding battery distribution plan is generated, so as to enable the available batteries after distribution to each road port to meet an actual battery swapping demand, and to ensure the accuracy of the battery distribution plan, and thus to realize automatic battery distribution to each road port during vehicle transportation. In this embodiment, the battery distribution mode in road ports during vehicle transportation is simplified, and the accuracy and the high efficiency of battery distribution in road ports are improved.

### Example Embodiment III

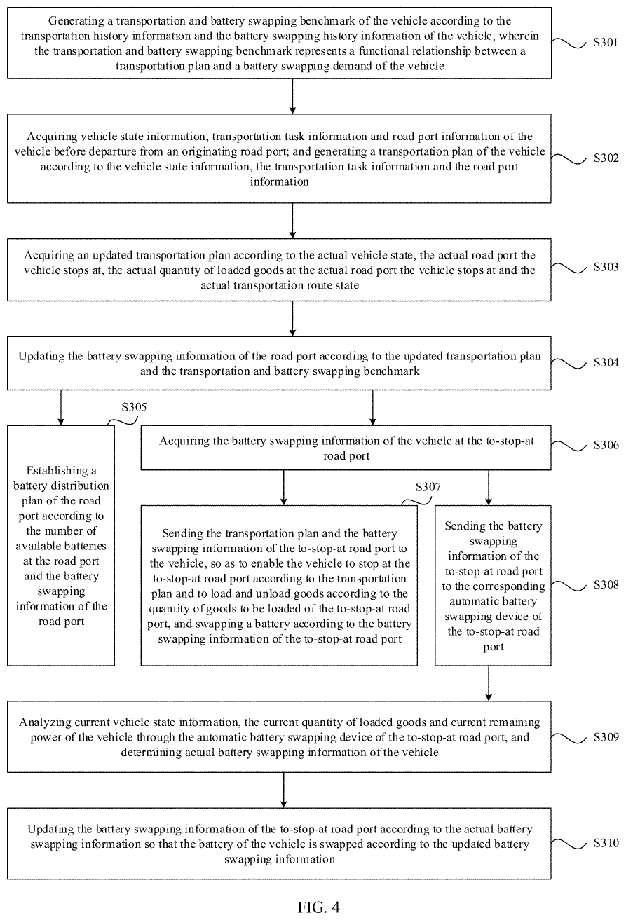

FIG. 4 is a schematic flowchart of a battery distribution method according to example Embodiment III of the present disclosure. This embodiment is optimized based on the above embodiment. Specifically, this embodiment mainly explains in detail the specific battery swapping procedure upon stopping of vehicles at road ports.

Specifically, as shown in FIG. 4, this embodiment may comprise the following steps:

At S301, a benchmark, which is also referred to as a battery swapping relationship, for transportation and battery swapping of the vehicle is generated according to the transportation history information and the battery swapping history information of the vehicle, wherein the benchmark represents a functional relationship between a transportation plan and a battery swapping demand of the vehicle.

At S302, vehicle state information, transportation task information and road port information of the vehicle (or for the vehicle) are acquired or produced, e.g., before the vehicle departs from an originating road port; and a transportation plan of the vehicle (or for the vehicle) is generated according to the vehicle state information, the transportation task information and the road port information.

The road port information may include, e.g., geographic location of the road port represented by, e.g., GPS coordinates of the road port. The transportation plan of the vehicle may comprise at least one road port and a quantity of goods to be loaded or unloaded onto or from the vehicle at the at least one road port.

Specifically, the vehicle, when departing from the originating road port, can request vehicle state information through the in-vehicle network, wherein the vehicle state information may include, but is not limited to, average power consumption, vehicle load, maximum battery charge, battery capacity, current load or weight of cargo or goods carried by the vehicle, and the like. The vehicle can also acquire transportation task information for the current/upcoming transportation, wherein the transportation task information may include a vehicle transportation route which may comprise a plurality of transportation sites, such as a transportation starting site, a transportation ending site and an approach site. In addition, the transportation task information of the vehicle may further include information of the quantity of goods to be loaded or unloaded to/from the vehicle at each transportation site.

Therefore, according to the example Embodiment III, the road port capable of providing various transportation services for vehicles during transportation can be determined by analyzing the transportation routes of the vehicle transportation task and the distribution of the road ports, and this road port can be taken as a road port the vehicles can stop at during transportation. Furthermore, since different quantities or weights of loaded goods of the vehicle (goods loaded in, into, or onto the vehicle) may also affect the power consumption of the vehicle during transportation, the quantity of loaded goods of the vehicle upon stopping at each road port (e.g., when/after the vehicle leaves the port) can be determined according to the information of the quantity of loaded goods of the vehicle at each transportation site, then the power consumption of the vehicle upon stopping at each road port (e.g., during vehicle travel between this road port and a next one along the travel route of the vehicle) is analyzed according to the vehicle state information and the quantity of loaded goods of the vehicle upon stopping at each road port, and the information such as the battery swapping number of the vehicle (the number of the vehicle batteries which need to be replaced) and, e.g., time until the next battery replacement upon or after stopping at each road port can be obtained according to the power consumption, so as to generate the transportation plan of the vehicle.

At S303, an updated transportation plan is obtained according to the current vehicle state information, road port(s) at which the vehicle has ever stopped (e.g., stopped during a preceding time interval such as, e.g., a week, a month, a year, etc.), the quantity of loaded goods (e.g., the weight of the goods that the vehicle is carrying) at the actual road port at which the vehicle has ever stopped (e.g., the weight of the goods that the vehicle is carrying upon arriving or upon departing from that port) and the actual transportation route state.

There can be a difference in the power consumption of the vehicle due to the fact that the vehicle, after departing from the originating road port, may change its actual transportation route according to actual road conditions and weather conditions, so that the transportation plan of the vehicle generated upon departure from the originating road port is not applicable to this vehicle any more. Therefore, in order to ensure the accuracy of the vehicle transportation plan, after an initial transportation plan is generated when the vehicle departs from the originating road port, the vehicle state information of the vehicle and the road port at which the vehicle has ever stopped are analyzed in real time during the actual vehicle transportation, and meanwhile, the quantity of loaded goods and the actual transportation route state of the vehicle at each road port (or between road ports) at which the vehicle has ever stopped are determined, so as to analyze the influence of the road conditions under the actual transportation state on the power consumption of the vehicle, and then to continuously update the transportation plan of the vehicle during the actual transportation, so that the battery swapping information of the road port can be updated by adopting the updated transportation plan and the benchmark, which ensures the accuracy of the battery swapping information of each road port.

At S304, the battery swapping information of the road port is updated according to the updated transportation plan and the benchmark.

At S305, a battery distribution plan of the road port is generated according to the number of available batteries at the road port and the battery swapping information of the road port.

At S306, the battery swapping demand of the vehicle at the road port is acquired or determined based on the transportation plan and the benchmark.

According to the example Embodiment III, when a battery distribution plan of each road port is generated, in order to ensure normal transportation and battery swapping of the vehicle, each road port the vehicle needs to stop at during the transportation, that is, the road port in this embodiment, is also determined, and the battery swapping demand of the vehicle in each road port is acquired or determined, so as to facilitate the stopping of the vehicle in the corresponding road port to implement a corresponding battery swapping operation. And the battery swapping demand will be updated once the transportation plan gets updated.

At S307, the transportation plan and the battery swapping demand of the vehicle at (each) road port are sent to the vehicle, so as to enable the vehicle to stop at the road port according to the transportation plan, goods are loaded and unloaded according to the quantity of goods to be loaded or unloaded at the road port, and a battery or batteries is/are swapped according to the battery swapping demand of the vehicle at the road port.

Optionally, in order to accurately control the vehicle transportation, the transportation plan of the vehicle and the battery swapping demand of the vehicle at the road port are sent to a corresponding battery swapping system on the vehicle, so as to enable the control of the vehicle to travel in a corresponding route by the battery swapping system according to this transportation plan, and to enable the stopping of the vehicle upon traveling to the road port. The vehicle can be controlled to load and/or unload goods according to the quantity of goods to be loaded or unloaded at each road port, and can be controlled to stop at a corresponding battery swapping position at the road port when the vehicle needs its battery or batteries to be swapped at the road port, so as to facilitate the battery swapping according to the battery swapping demand of the vehicle at the road port.

S308, the battery swapping demand of the vehicle at the road port is sent to the corresponding automatic battery swapping device of the road port.

When the vehicle stops at the road port, in order to ensure the successful battery swapping of the vehicle, the battery swapping demand of the vehicle at the road port can be sent to the corresponding automatic battery swapping device of the road port, so that when the vehicle stops at the road port, the automatic battery swapping device of the road port can accurately swap the battery of the vehicle according to the battery swapping demand of the vehicle at the road port.

It should be noted that, the steps before steps S307 and S308 are not necessarily implemented in sequence, and steps S307 and S308, after S306 is completed, can be implemented synchronously.

At S309, current vehicle state information, the current quantity of loaded goods and current remaining power of the vehicle are analyzed through the automatic battery swapping device of the road port, so as to determine an actual battery swapping demand of the vehicle.

Optionally, in order to ensure the accuracy of the battery swapping demand of the vehicle in the road port, in this embodiment, when the vehicle stops at the road port, the current vehicle state information, the current quantity of loaded goods and the current remaining power of the vehicle can be analyzed through or using the automatic battery swapping device of the road port, so as to determine an actual transportation situation or condition and an actual power consumption situation or condition or state of the vehicle, and thus to determine the actual battery swapping demand of the vehicle upon stopping at the road port.

At S310, the battery swapping information of the road port is updated according to the actual battery swapping information, to obtain or produce an updated battery swapping information, so that the battery of the vehicle is swapped according to the updated battery swapping information.

The actual battery swapping information of the road port can be substituted for the existing battery swapping information of the road port through or using an automatic battery swapping device of the road port, so as to update the battery swapping information of the road port, and then the vehicle can be subjected to battery swapping according to the actual battery swapping information, thereby ensuring the accuracy of the battery swapping of the vehicle.

It should be noted that, in order to ensure the high efficiency of battery swapping of a vehicle, when the vehicle is going to stop at a certain road port, a corresponding battery swapping position can be allocated for the vehicle through an automatic battery swapping device of the road port according to the battery swapping demand of the vehicle at each road port, and a reservation can be made for battery swapping on the battery swapping position. That is to say, before a vehicle stops at any road port, an automatic battery swapping device of the road port may analyze a current position of the vehicle and an estimated stopping time when the vehicle arrives at the road port in advance, then may select the most suitable battery swapping position from all the battery swapping positions and a battery swapping machine for the vehicle by combining the information such as the number of battery swapping machines, the number of batteries thereof, the type of the vehicle, the state of each battery swapping machines and the battery swapping queuing situation in the road port, and makes a reservation for battery swapping on the battery swapping machine so as to avoid the waste of time due to the necessary queue for battery swapping of the vehicle upon entering the road port and thus to improve the high efficiency of battery swapping of the vehicles.

In addition, the automatic battery swapping device of the road port may receive a battery swapping payment message after the successful battery swapping. That is to say, the vehicle, when stopping at any road port, can, e.g., scan a two-dimensional code provided on the automatic battery swapping device of the road port by its vehicle-mounted camera for online payment, and/or may complete payment in other modes such as via monthly settlement through or using vehicle identification, so as to enable the automatic battery swapping device of the road port to receive a battery swapping payment message after the successful battery swapping and thus to realize the successful battery swapping of the vehicle.

It should be noted that, steps S305 and S306-S310 in this embodiment can be implemented synchronously, not necessarily in any specific sequence, after S304 is completed.

According to the technical scheme provided by the example Embodiment III, a functional relationship between a transportation plan and a battery swapping demand during vehicle transportation can be analyzed or determined according to transportation history information and battery swapping history information of a vehicle to obtain a corresponding benchmark for transportation and battery swapping. For example, the battery swapping demand of the vehicle can be determined based on the transportation plan and the benchmark. And the battery swapping information of a road port can be determined based on the battery swapping demand of the vehicle, so the battery swapping information of the road port can be updated according to the transportation plan of the vehicle and the benchmark, and further a battery distribution plan of the road port may be generated according to the number of available batteries at the road port and the battery swapping information of the road port so as to enable the available batteries after the distribution to each road port to meet an actual battery swapping demand, to ensure the success rate and accuracy of battery swapping of the vehicle and thus to realize the automatic battery distribution in road ports during the vehicle transportation. In this embodiment, the battery distribution mode in road ports during the vehicle transportation is simplified, the problems of the complicated distribution mode and heavy distribution workload during manual battery distribution for each road port are solved, and the accuracy and the high efficiency of battery distribution in road ports are improved.

### Example Embodiment IV

FIG. 5 is a schematic diagram showing the structure of a battery distribution device according to the example Embodiment IV of the present disclosure. As shown in FIG. 5, this device may comprise: a battery swapping benchmark generation module 410, configured to generate a benchmark for transportation and battery swapping of a vehicle according to transportation history information and battery swapping history information of the vehicle, wherein the benchmark represents a functional relationship between a transportation plan and a battery swapping demand of the vehicle; a battery swapping updating module 420, configured to update the battery swapping information of a road port according to the transportation plan of the vehicle and the benchmark; and a battery distribution module 430, configured to generate a battery distribution plan of the road port according to the number of available batteries at the road port and the battery swapping information of the road port.

According to the technical scheme provided by the example Embodiment IV, a functional relationship between a transportation plan and a battery swapping demand during vehicle transportation can be analyzed or generated according to transportation history information and battery swapping history information of a vehicle to obtain a corresponding benchmark for transportation and battery swapping. Furthermore, the battery swapping information of each road port (e.g., each road port in which the vehicle is supposed to make a stop (either for battery replacement/swapping or otherwise), e.g., according to the transportation plan of the vehicle) can be updated according to the transportation plan of the vehicle and the benchmark, and furthermore a battery distribution plan of the road port can be generated according to the number of available batteries at the road port and the battery swapping information of the road port so as to enable the available batteries after the distribution of batteries to each road port to meet the actual battery swapping demand and thus to realize the automatic battery distribution in road ports during the vehicle transportation. In this embodiment, the battery distribution mode in road ports during the vehicle transportation is simplified, the problems of the complicated distribution mode and heavy distribution workload during manual battery distribution to each road port are solved, and the accuracy and the high efficiency of battery distribution to road ports are improved.

The battery swapping information of a road port may at least include: each stopping time for battery swapping at the road port, vehicle information corresponding to each stopping time for battery swapping, and/or a power exchange amount corresponding to each stopping time for battery swapping.

Furthermore, the battery distribution module 430 may be specifically configured to: determine a battery distribution or delivery path and battery distribution time for the road port according to the number of available batteries at the road port, the first stopping time for battery swapping and the power exchange amount corresponding to the first stopping time for battery swapping; determine the number of batteries for distribution or delivery to the road port according to the power exchange amount corresponding to each stopping time for battery swapping and the number of available batteries at the road port; and generate a corresponding battery distribution plan based on the battery distribution path, the battery distribution time and the number of batteries for distribution or delivery at the road port.

The battery distribution device may further comprise an available battery determination module, configured to acquire the number of available batteries at the road port through (or by or using) an automatic battery swapping device at the road port in response to a battery swapping operation successfully implemented each time at the road port.

The battery distribution device may also comprise a battery swapping information updating module, configured to update the battery swapping information of the road port according to vehicle state information of the vehicle, an actual road port the vehicle stops at, an actual quantity of loaded goods at the actual road port the vehicle stops at and an actual transportation route state.

The vehicle state information of the vehicle may include: a vehicle weight, a loading capacity, average power consumption, and/or remaining power of the vehicle. The actual transportation route state may include: actual weather information of the transportation route, road congestion information, and/or a running state of the road port.

Furthermore, a timing of generating the battery distribution plan of the road port may comprise any of the following timings: in response to a request of a vehicle for departure from a road port, for example, an originating road port from which the vehicle starts the transportation; in response to a battery swapping operation implemented by an automatic battery swapping device at a road port on a vehicle; in response to distribution of standby batteries at each road port is finished according to the latest battery distribution plan; or in response to the condition where the number of available batteries at any road port is less than or equal to a preset battery swapping threshold.

Furthermore, the above battery distribution device may further comprise a transportation plan generation module, configured to acquire or produce vehicle state information, transportation task information and road port information before the vehicle departs from an originating road port, and to generate a transportation plan of the vehicle according to the vehicle state information, the transportation task information and the road port information, wherein the transportation plan comprises at least one road port and the quantity of goods to be loaded or unloaded at the at least one road port.

The above battery distribution device may also comprise a transportation plan updating module, configured to acquire or generate an updated transportation plan according to the actual vehicle state, the actual road port the vehicle stops at, the actual quantity of loaded goods (e.g., the actual weight of the goods the vehicle is carrying or transporting) at the actual road port the vehicle stops at and the actual transportation route state, and to update the battery swapping information of the road port according to the updated transportation plan and the benchmark.

Furthermore, the above battery distribution device may further comprise a vehicle transportation control module, configured to acquire battery swapping demand of the vehicle at the road port, send the transportation plan and the battery swapping demand of the vehicle at the road port to the vehicle, so as to enable the vehicle to stop at the road port according to the transportation plan and to load or unload goods according to the quantity of goods to be loaded or unloaded at the road port, and to swap a battery according to the battery swapping demand of the vehicle at the road port.

The battery distribution device may further comprise a battery swapping information forwarding module, configured to acquire or receive battery swapping demand of the vehicle at the road port, and send the battery swapping demand of the vehicle at the road port to the corresponding automatic battery swapping device of the road port.

The battery distribution device may also comprise a vehicle battery swapping module, configured to analyze current vehicle state information, the current quantity of loaded goods and current remaining power of the vehicle through the automatic battery swapping device of the road port so as to determine actual battery swapping demand of the vehicle, and to update the battery swapping information of the road port according to the actual battery swapping demand so that the battery of the vehicle is swapped according to the updated battery swapping information.

Furthermore, the battery distribution device may further comprise a battery swapping reservation module, configured to allocate a corresponding battery swapping position for the vehicle through the automatic battery swapping device of the road port according to the battery swapping demand of the vehicle at the road port, and make a reservation for battery swapping on the battery swapping position.

The battery distribution device provided by this embodiment is applicable to the battery distribution method provided by any one of the above embodiments, and has corresponding functions and beneficial effects.

### Example Embodiment V

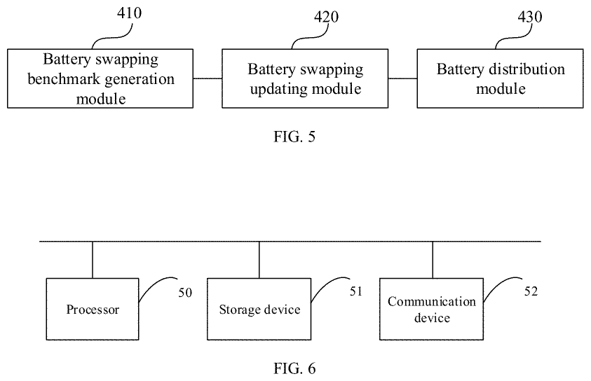

FIG. 6 is a schematic diagram showing the structure of a server according to the example Embodiment V of the present disclosure. As shown in FIG. 6, the server may comprise a processor 50, a storage device 51 and a communication device 52, wherein there may be one or more processors 50 in the server, and one processor 50 is taken as an example in FIG. 6; the processor 50, the storage device 51 and the communication device 52 of the server may be connected by a bus or in other manners, and the bus connection is taken as an example in FIG. 6.

The storage device 51, as a computer-readable storage medium, can be configured to store software programs, computer-executable programs and modules. The processor 50 can be configured to execute various functional applications of the server and data processing by running the software programs, instructions and modules stored in the storage device 51, so as to implement the above-mentioned battery distribution method.

The storage device 51 may mainly include a program storage area and a data storage area, wherein the program storage area may store an operating system and at least one functional application program; the data storage area may store data generated according to the use of a terminal, and the like. Furthermore, the storage device 51 may comprise a high speed random access memory, and may further comprise a non-volatile memory, such as at least one magnetic disk memory, flash memory, or other non-volatile solid state memory. In some examples, the storage device 51 may further comprise a memory disposed remotely from a multifunction controller 50. All these remote memories may be connected to an electronic device via a network. Examples of the above network include, but are not limited to, the Internet, intranets, local area networks, mobile communication networks, and combinations thereof.

The communication device 52 may be configured to realize a network connection or a mobile data connection between devices.

The server provided by this embodiment can be configured to implement the battery distribution method provided by any one of the above embodiments, and has corresponding functions and beneficial effects.

### Example Embodiment VI

Example Embodiment VI further provides a computer-readable storage medium, having a computer program stored thereon, wherein the program, when executed by a processor, cause the processor to implement the battery distribution method according to any one of the embodiments. The method may comprise: generating a benchmark for transportation and battery swapping of a vehicle according to transportation history information and battery swapping history information of the vehicle, wherein the benchmark represents a functional relationship between a transportation plan and a battery swapping demand of the vehicle; updating the battery swapping information of a road port according to the transportation plan of the vehicle and the benchmark; and generating a battery distribution plan of the road port according to the number of available batteries at the road port and the battery swapping information of the road port.

Certainly, the computer-executable instructions contained in the storage medium provided in the embodiments of the present disclosure are not limited to the procedures in the method described above but may also comprise related procedures in the battery distribution method provided in any one of the embodiments.

An aspect of the disclosed embodiments relates to a battery distribution method, comprising: generating a relationship between a transportation plan and a battery swapping demand of a vehicle using transportation history information and battery swapping history information of the vehicle; updating battery swapping information of a road port according to the transportation plan of the vehicle and the relationship, wherein the battery swapping information of the road port is determined based on the battery swapping demand of one or more vehicles; and generating a battery distribution plan for the road port according to a number of available batteries at the road port and the battery swapping information of the road port.

In some example embodiments of the battery distribution method, the battery swapping information of the road port includes: stopping time for battery swapping at the road port, vehicle information corresponding to the stopping time for battery swapping, and a power exchange amount corresponding to the stopping time for battery swapping.

According to some example embodiments, the generating the battery distribution plan for the road port comprises: determining a battery distribution path and battery distribution time of the road port according to the number of available batteries at the road port, a first stopping time for battery swapping and a power exchange amount corresponding to the first stopping time for battery swapping; determining the number of batteries for distribution to the road port according to the power exchange amount corresponding to one or more stopping times for battery swapping and the number of available batteries at the road port; and generating the battery distribution plan based on the battery distribution path, the battery distribution time and the number of batteries for distribution to the road port. In an example embodiment, the method further comprises updating the number of available batteries at the road port through an automatic battery swapping device at the road port in response to each battery swapping operation implemented at the road port. In another example embodiment, the method further comprises updating the battery swapping information of the road port according to vehicle state information of the vehicle, a road port at which the vehicle has ever stopped, quantity of loaded or unloaded goods at the road port at which the vehicle has ever stopped and an actual state of transportation route. in some example embodiments, the vehicle state information of the vehicle includes: a weight of the vehicle, a loading capacity of the vehicle, average power consumption of the vehicle, or remaining power of the vehicle; and wherein the actual state of transportation route includes: weather information related to the transportation route, road congestion information for the transportation route, or a running state of the road port. In an example embodiment, the generating the battery distribution plan for the road port comprises: generating the battery distribution plan for the road port in response to at least one of: a request of the vehicle for departure from a road port; a battery swapping operation implemented by an automatic battery swapping device at the road port on the vehicle; distribution of batteries to the road port finished according to a latest battery distribution plan; or a condition where the number of available batteries at the road port is less than or equal to a preset battery swapping threshold. According to some example embodiments, the method further comprises acquiring vehicle state information, transportation task information and road port information corresponding to the vehicle before departure of the vehicle from an originating road port; and generating a transportation plan of the vehicle according to the vehicle state information, the transportation task information and the road port information, wherein the transportation plan comprises at least one road port for the vehicle to stop at and a quantity of goods to be loaded or unloaded at the at least one road port. In certain example embodiments, the method further comprises: updating the transportation plan according to current vehicle state information of the vehicle, the road port at which the vehicle has ever stopped, the quantity of loaded goods at the road port at which the vehicle has ever stopped and the actual state of transportation route, to obtain an updated transportation plan; and updating the battery swapping information of the road port according to the updated transportation plan and the relationship. According to an example embodiment, the method further comprises: determining battery swapping demand of the vehicle at the road port according to the transportation plan and the relationship; and sending the transportation plan and the battery swapping demand of the vehicle at the road port to the vehicle, so as to enable the vehicle to stop at the road port according to the transportation plan and to load or unload goods according to the quantity of goods to be loaded or unloaded at the road port, and to swap a battery according to the battery swapping demand of the vehicle at the road port. In some example embodiments, the method further comprises: determining battery swapping demand of the vehicle at the road port according to the transportation plan and the relationship; and sending the battery swapping demand of vehicle at the road port to the corresponding automatic battery swapping device of the road port. In an example embodiment, the method further comprises: updating the battery swapping demand of the vehicle based on current vehicle state information of the vehicle, current quantity of loaded goods and current remaining power of the vehicle using the automatic battery swapping device of the road port, to obtain an updated battery swapping demand of the vehicle; and updating the battery swapping information of the road port according to the updated battery swapping demand of the vehicle to obtain an updated battery swapping information of the road port, so that the battery of the vehicle is swapped according to the updated battery swapping information of the road port. In another example embodiment, the method further comprises: allocating a corresponding battery swapping position for the vehicle through the automatic battery swapping device of the road port according to the battery swapping demand of the vehicle at the road port; and making a reservation for battery swapping on the battery swapping position.

Another aspect of the disclosed embodiments relates to a battery distribution device, comprising: a battery swapping benchmark generation module, configured to generate a benchmark for transportation and battery swapping of a vehicle according to transportation history information and battery swapping history information of the vehicle, wherein the benchmark represents a corresponding relationship between a transportation plan and a battery swapping demand of the vehicle; a battery swapping updating module, configured to update battery swapping information of a road port according to the transportation plan of the vehicle and the benchmark, wherein the battery swapping information of the road port is determined based on battery swapping demand of one or more vehicles; and a battery distribution module, configured to generate a battery distribution plan of the road port according to a number of available batteries at the road port and the battery swapping information of the road port.

In an example embodiment of the battery distribution device, the battery swapping information of the road port at least includes: stopping time for battery swapping at the road port, vehicle information corresponding to the stopping time for battery swapping, and a power exchange amount corresponding to the stopping time for battery swapping. In another example embodiment, the battery distribution module is configured to: determine a battery distribution path and battery distribution time of the road port according to the number of available batteries at the road port, a first stopping time for battery swapping and a power exchange amount corresponding to the first stopping time for battery swapping; determine the number of batteries for distribution to the road port according to the power exchange amount corresponding to one or more stopping times for battery swapping and the number of available batteries at the road port; and generate the battery distribution plan based on the battery distribution path, the battery distribution time and the number of batteries for distribution to the road port. In some example embodiments, the device further comprises: a battery swapping information updating module, configured to update the battery swapping information of the road port according to vehicle state information of the vehicle, a road port at which the vehicle has ever stopped, quantity of loaded or unloaded goods at the road port at which the vehicle has ever stopped and an actual state of transportation route.

Yet another aspect of the disclosed embodiments relates to a battery distribution system, comprising a battery swapping planning system, an automatic battery swapping device and a battery swapping system, wherein the battery swapping planning system is configured to: generate a benchmark for transportation and battery swapping of a vehicle according to transportation history information and battery swapping history information of the vehicle, the benchmark representing a corresponding relationship between a transportation plan and a battery swapping demand of the vehicle; update the battery swapping information of a road port according to the transportation plan and the benchmark; generate a battery distribution plan of the road port according to a number of available batteries at the road port and the battery swapping information of the road port; and send the transportation plan generated for the vehicle and the battery swapping demand of the vehicle at the road port to the battery swapping system on the vehicle; and the battery swapping system is configured to: receive the transportation plan generated by the battery swapping planning system for the vehicle and the battery swapping demand of the vehicle at the road port; enable the vehicle to stop at the road port according to the transportation plan and load or unload goods according to quantity of goods to be loaded or unloaded at the road port; and send the battery swapping demand of vehicle to the automatic battery swapping device in the road port, wherein the automatic battery swapping device is configured to swap a battery of the vehicle according to the battery swapping demand of the vehicle upon the vehicle stopping at the road port.

An aspect of the disclosed embodiments relates to a server, comprising: one or more processors; and a storage device configured to store one or more programs, wherein the one or more programs, upon execution by the one or more processors, cause the server to implement a battery distribution method according to the present disclosure.

Another aspect of the disclosed embodiments relates to a non-transitory computer-readable storage medium, having a computer program stored thereon, wherein the program, when executed by a processor, causes the processor to implement a battery distribution method according to the present disclosure.

An aspect of the disclosed embodiments relates to a method of replacing a battery of an autonomous vehicle, comprising: determining, based on a travel plan and a battery swapping demand of the autonomous vehicle, a location for replacing one or more batteries of the autonomous vehicle.

In some example embodiments, the location is a location of a road port along a travel route of the autonomous vehicle. In an example embodiment, the travel plan of the autonomous vehicle includes information related to a travel route of the autonomous vehicle and a weight of goods carried by the vehicle along the route. According to some example embodiments, the battery swapping demand of the autonomous vehicle includes a battery capacity required to move the autonomous vehicle a predetermined distance when the autonomous vehicle is carrying a predetermined weight of goods. In some example embodiments, the method further comprises determining a number of batteries of the autonomous vehicle which need to be replaced at the location based on the battery swapping demand of the autonomous vehicle, a weight of the vehicle, and a distance between the autonomous vehicle and the location.

From the above description of the embodiments, it is obvious for those skilled in the art that the present invention can be implemented either through software and necessary general hardware or through hardware, but the former is a better embodiment in many cases. Based on such understanding, the technical scheme of the present invention or part thereof contributing to the prior art may be embodied in the form of a software product. The soft product can be stored in a computer-readable storage medium, such as a floppy disk, a read-only memory (ROM), a random access memory (RAM), a flash memory (FLASH), a hard disk or an optical disk of a computer, and comprises several instructions for enabling a computer device (which may be a personal computer, a server, or a network device) to implement the method according to the disclosed embodiments.

It should be noted that, in the embodiment of the battery distribution device, the units and modules comprised are merely divided according to the functional logic, and other divisions are also possible as long as the corresponding functions can be implemented; in addition, the specific names of the functional units are only for the convenience of distinguishing from one another, and are not used for limiting the protection scope.

It is to be noted that the above description is only preferred embodiments and the principles of the employed technologies. Those skilled in the art will appreciate that the present invention is not limited to the particular embodiments described herein, and those skilled in the art can make various obvious changes, rearrangements and substitutions without departing from the protection scope of the present invention. Therefore, although the present invention has been described in some detail by the above embodiments, it is not limited to the above embodiments, and may further include other equivalent embodiments without departing from the spirit of the present invention, and the scope of the present invention is determined by the scope of the appended claims.

Some preferred embodiments may include the following:

1. A battery distribution method, comprising:

generating a relationship between a transportation plan and a battery swapping demand of a vehicle using transportation history information and battery swapping history information of the vehicle;

updating battery swapping information of a road port according to the transportation plan of the vehicle and the relationship, wherein the battery swapping information of the road port is determined based on a battery swapping demand of one or more vehicles; and

generating a battery distribution plan for the road port according to a number of available batteries at the road port and the battery swapping information of the road port.

2. The method according to solution 1, wherein the battery swapping information of the road port includes: stopping time for battery swapping at the road port, vehicle information corresponding to the stopping time for battery swapping, and a power exchange amount corresponding to the stopping time for battery swapping.

3. The method according to solution 2, wherein the generating the battery distribution plan for the road port comprises:

determining a battery distribution path and battery distribution time of the road port according to the number of available batteries at the road port, a first stopping time for battery swapping and a power exchange amount corresponding to the first stopping time for battery swapping;

determining the number of batteries for distribution to the road port according to the power exchange amount corresponding to one or more stopping times for battery swapping and the number of available batteries at the road port; and

generating the battery distribution plan based on the battery distribution path, the battery distribution time and the number of batteries for distribution to the road port.

4. The method according to solution 3, further comprising:

updating the number of available batteries at the road port through an automatic battery swapping device at the road port in response to each battery swapping operation implemented at the road port.

5. The method according to solution 2, further comprising:

updating the battery swapping information of the road port according to vehicle state information of the vehicle, a road port at which the vehicle has ever stopped, quantity of loaded or unloaded goods at the road port at which the vehicle has ever stopped and an actual state of transportation route.

6. The method according to solution 5, wherein the vehicle state information of the vehicle includes: a weight of the vehicle, a loading capacity of the vehicle, average power consumption of the vehicle, or remaining power of the vehicle; and wherein the actual state of transportation route includes: weather information related to the transportation route, road congestion information for the transportation route, or a running state of the road port.

7. The method according to any one of solutions 1-6, wherein the generating the battery distribution plan for the road port comprises:

generating the battery distribution plan for the road port in response to at least one of:

a request of the vehicle for departure from a road port;

a battery swapping operation implemented by an automatic battery swapping device at the road port on the vehicle;

distribution of batteries to the road port finished according to a latest battery distribution plan; or

a condition where the number of available batteries at the road port is less than or equal to a preset battery swapping threshold.

8. The method according to any one of solutions 1-6, further comprising:

acquiring vehicle state information, transportation task information and road port information corresponding to the vehicle before departure of the vehicle from an originating road port; and

generating a transportation plan of the vehicle according to the vehicle state information, the transportation task information and the road port information, wherein the transportation plan comprises at least one road port for the vehicle to stop at and a quantity of goods to be loaded or unloaded at the at least one road port.

9. The method according to solution 8, further comprising:

updating the transportation plan according to current vehicle state information of the vehicle, the road port at which the vehicle has ever stopped, the quantity of loaded goods at the road port at which the vehicle has ever stopped and the actual state of transportation route, to obtain an updated transportation plan; and

updating the battery swapping information of the road port according to the updated transportation plan and the relationship.

10. The method according to solution 8, further comprising:

determining battery swapping demand of the vehicle at the road port according to the transportation plan and the relationship; and

sending the transportation plan and the battery swapping demand of the vehicle at the road port to the vehicle, so as to enable the vehicle to stop at the road port according to the transportation plan and to load or unload goods according to the quantity of goods to be loaded or unloaded at the road port, and to swap a battery according to the battery swapping demand of the vehicle at the road port.

11. The method according to solution 8, further comprising:

determining battery swapping demand of the vehicle at the road port according to the transportation plan and the relationship; and

sending the battery swapping demand of vehicle at the road port to the corresponding automatic battery swapping device of the road port.

12. The method according to solution 11, further comprising:

updating the battery swapping demand of the vehicle based on current vehicle state information of the vehicle, current quantity of loaded goods and current remaining power of the vehicle using the automatic battery swapping device of the road port, to obtain an updated battery swapping demand of the vehicle; and

updating the battery swapping information of the road port according to the updated battery swapping demand of the vehicle to obtain an updated battery swapping information of the road port, so that the battery of the vehicle is swapped according to the updated battery swapping information of the road port.

13. The method according to solution 11, further comprising:

allocating a corresponding battery swapping position for the vehicle through the automatic battery swapping device of the road port according to the battery swapping demand of the vehicle at the road port; and

making a reservation for battery swapping on the battery swapping position.

14. A battery distribution device, comprising:

a battery swapping benchmark generation module, configured to generate a benchmark for transportation and battery swapping of a vehicle according to transportation history information and battery swapping history information of the vehicle, wherein the benchmark represents a corresponding relationship between a transportation plan and a battery swapping demand of the vehicle;

a battery swapping updating module, configured to update battery swapping information of a road port according to the transportation plan of the vehicle and the benchmark, wherein the battery swapping information of the road port is determined based on battery swapping demand of one or more vehicles; and

a battery distribution module, configured to generate a battery distribution plan of the road port according to a number of available batteries at the road port and the battery swapping information of the road port.

15. The device according to solution 14, wherein the battery swapping information of the road port at least includes: stopping time for battery swapping at the road port, vehicle information corresponding to the stopping time for battery swapping, and a power exchange amount corresponding to the stopping time for battery swapping.

16. The device according to solution 15, wherein the battery distribution module is configured to:

determine a battery distribution path and battery distribution time of the road port according to the number of available batteries at the road port, a first stopping time for battery swapping and a power exchange amount corresponding to the first stopping time for battery swapping;

determine the number of batteries for distribution to the road port according to the power exchange amount corresponding to one or more stopping times for battery swapping and the number of available batteries at the road port; and

generate the battery distribution plan based on the battery distribution path, the battery distribution time and the number of batteries for distribution to the road port.

17. The device according to solution 15, further comprising:

a battery swapping information updating module, configured to update the battery swapping information of the road port according to vehicle state information of the vehicle, a road port at which the vehicle has ever stopped, quantity of loaded or unloaded goods at the road port at which the vehicle has ever stopped and an actual state of transportation route.

18. A battery distribution system, comprising a battery swapping planning system, an automatic battery swapping device and a battery swapping system, wherein

the battery swapping planning system is configured to: generate a benchmark for transportation and battery swapping of a vehicle according to transportation history information and battery swapping history information of the vehicle, the benchmark representing a corresponding relationship between a transportation plan and a battery swapping demand of the vehicle; update the battery swapping information of a road port according to the transportation plan and the benchmark; generate a battery distribution plan of the road port according to a number of available batteries at the road port and the battery swapping information of the road port; and send the transportation plan generated for the vehicle and the battery swapping demand of the vehicle at the road port to the battery swapping system on the vehicle; and

the battery swapping system is configured to: receive the transportation plan generated by the battery swapping planning system for the vehicle and the battery swapping demand of the vehicle at the road port; enable the vehicle to stop at the road port according to the transportation plan and load or unload goods according to quantity of goods to be loaded or unloaded at the road port; and send the battery swapping demand of vehicle to the automatic battery swapping device in the road port, wherein the automatic battery swapping device is configured to swap a battery of the vehicle according to the battery swapping demand of the vehicle upon the vehicle stopping at the road port.

19. A server, comprising: one or more processors; and a storage device configured to store one or more programs, wherein the one or more programs, upon execution by the one or more processors, cause the server to implement the battery distribution method according to any one of solutions 1-13.

20. A non-transitory computer-readable storage medium, having a computer program stored thereon, wherein the program, when executed by a processor, causes the processor to implement the battery distribution method according to any one of solutions 1-13.

21. A method of replacing a battery of an autonomous vehicle, comprising:

determining, based on a travel plan and a battery swapping demand of the autonomous vehicle, a location for replacing one or more batteries of the autonomous vehicle.

22. The method of solution 21, wherein the location is a location of a road port along a travel route of the autonomous vehicle.

23. The method of solution 21, wherein the travel plan of the autonomous vehicle includes information related to a travel route of the autonomous vehicle and a weight of goods carried by the vehicle along the route.

24. The method of solution 21, wherein the battery swapping demand of the autonomous vehicle includes a battery capacity required to move the autonomous vehicle a predetermined distance when the autonomous vehicle is carrying a predetermined weight of goods.

25. The method of solution 21, comprising determining a number of batteries of the autonomous vehicle which need to be replaced at the location based on the battery swapping demand of the autonomous vehicle, a weight of the vehicle, and a distance between the autonomous vehicle and the location.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A battery distribution method, comprising:
generating a relationship between a transportation plan and a battery swapping demand of a vehicle using transportation history information and battery swapping history information of the vehicle;
updating battery swapping information of a road port according to the transportation plan of the vehicle and the relationship, wherein the battery swapping information of the road port is determined based on a battery swapping demand of one or more vehicles; and
generating a battery distribution plan for the road port according to a number of available batteries at the road port and the battery swapping information of the road port.

2. The method according to claim 1, wherein the battery swapping information of the road port includes: stopping time for battery swapping at the road port, vehicle information corresponding to the stopping time for battery swapping, and a power exchange amount corresponding to the stopping time for battery swapping.

3. The method according to claim 2, wherein the generating the battery distribution plan for the road port comprises:
determining a battery distribution path and battery distribution time of the road port according to the number of available batteries at the road port, a first stopping time for battery swapping and a power exchange amount corresponding to the first stopping time for battery swapping;
determining the number of batteries for distribution to the road port according to the power exchange amount corresponding to one or more stopping times for battery swapping and the number of available batteries at the road port; and
generating the battery distribution plan based on the battery distribution path, the battery distribution time and the number of batteries for distribution to the road port.

4. The method according to claim 3, further comprising:
updating the number of available batteries at the road port through an automatic battery swapping device at the road port in response to each battery swapping operation implemented at the road port.

5. The method according to claim 2, further comprising:
updating the battery swapping information of the road port according to vehicle state information of the vehicle, a road port at which the vehicle has ever stopped, quantity of loaded or unloaded goods at the road port at which the vehicle has ever stopped and an actual state of transportation route.

6. The method according to claim 5, wherein the vehicle state information of the vehicle includes: a weight of the vehicle, a loading capacity of the vehicle, average power consumption of the vehicle, or remaining power of the vehicle; and wherein the actual state of transportation route includes: weather information related to the transportation route, road congestion information for the transportation route, or a running state of the road port.

7. The method according claim 3, wherein the generating the battery distribution plan for the road port comprises:
generating the battery distribution plan for the road port in response to at least one of:
a request of the vehicle for departure from a road port;
a battery swapping operation implemented by an automatic battery swapping device at the road port on the vehicle;
distribution of batteries to the road port finished according to a latest battery distribution plan; or
a condition where the number of available batteries at the road port is less than or equal to a preset battery swapping threshold.

8. The method according to claim 5, further comprising:
acquiring vehicle state information, transportation task information and road port information corresponding to the vehicle before departure of the vehicle from an originating road port; and
generating a transportation plan of the vehicle according to the vehicle state information, the transportation task information and the road port information, wherein the transportation plan comprises at least one road port for the vehicle to stop at and a quantity of goods to be loaded or unloaded at the at least one road port.

9. The method according to claim 8, further comprising:
updating the transportation plan according to current vehicle state information of the vehicle, the road port at which the vehicle has ever stopped, the quantity of loaded goods at the road port at which the vehicle has ever stopped and the actual state of transportation route, to obtain an updated transportation plan; and
updating the battery swapping information of the road port according to the updated transportation plan and the relationship.

10. The method according to claim 8, further comprising:
determining battery swapping demand of the vehicle at the road port according to the transportation plan and the relationship; and
sending the transportation plan and the battery swapping demand of the vehicle at the road port to the vehicle or to an corresponding automatic battery swapping device of the road port, so as to enable the vehicle to stop at the road port according to the transportation plan and to load or unload goods according to the quantity of goods to be loaded or unloaded at the road port, and to swap a battery according to the battery swapping demand of the vehicle at the road port.

11. The method according to claim 10, further comprising:
updating the battery swapping demand of the vehicle based on current vehicle state information of the vehicle, current quantity of loaded goods and current remaining power of the vehicle using the automatic battery swapping device of the road port, to obtain an updated battery swapping demand of the vehicle; and
updating the battery swapping information of the road port according to the updated battery swapping demand of the vehicle to obtain an updated battery swapping information of the road port, so that the battery of the vehicle is swapped according to the updated battery swapping information of the road port.

12. The method according to claim 10, further comprising:
allocating a corresponding battery swapping position for the vehicle through the automatic battery swapping device of the road port according to the battery swapping demand of the vehicle at the road port; and
making a reservation for battery swapping on the battery swapping position.

13. A battery distribution device, comprising:
a battery swapping benchmark generation module, configured to generate a benchmark for transportation and battery swapping of a vehicle according to transportation history information and battery swapping history information of the vehicle, wherein the benchmark represents a corresponding relationship between a transportation plan and a battery swapping demand of the vehicle;
a battery swapping updating module, configured to update battery swapping information of a road port according to the transportation plan of the vehicle and the benchmark, wherein the battery swapping information of the road port is determined based on battery swapping demand of one or more vehicles; and
a battery distribution module, configured to generate a battery distribution plan of the road port according to a number of available batteries at the road port and the battery swapping information of the road port.

14. The device according to claim 13, wherein the battery swapping information of the road port at least includes: stopping time for battery swapping at the road port, vehicle information corresponding to the stopping time for battery swapping, and a power exchange amount corresponding to the stopping time for battery swapping.

15. The device according to claim 14, wherein the battery distribution module is configured to:
determine a battery distribution path and battery distribution time of the road port according to the number of available batteries at the road port, a first stopping time for battery swapping and a power exchange amount corresponding to the first stopping time for battery swapping;
determine the number of batteries for distribution to the road port according to the power exchange amount corresponding to one or more stopping times for battery swapping and the number of available batteries at the road port; and
generate the battery distribution plan based on the battery distribution path, the battery distribution time and the number of batteries for distribution to the road port.

16. The device according to claim 13, further comprising:
a battery swapping information updating module, configured to update the battery swapping information of the road port according to vehicle state information of the vehicle, a road port at which the vehicle has ever stopped, quantity of loaded or unloaded goods at the road port at which the vehicle has ever stopped and an actual state of transportation route.

17. A method of replacing a battery of an autonomous vehicle, comprising:
determining, based on a travel plan and a battery swapping demand of the autonomous vehicle, a location for replacing one or more batteries of the autonomous vehicle.

18. The method of claim 17, wherein the travel plan of the autonomous vehicle includes information related to a travel route of the autonomous vehicle and a weight of goods carried by the vehicle along the route.

19. The method of claim 17, wherein the battery swapping demand of the autonomous vehicle includes a battery capacity required to move the autonomous vehicle a predetermined distance when the autonomous vehicle is carrying a predetermined weight of goods.

20. The method of claim 17, comprising determining a number of batteries of the autonomous vehicle which need to be replaced at the location based on the battery swapping demand of the autonomous vehicle, a weight of the vehicle, and a distance between the autonomous vehicle and the location.
